(19) United States
(12) Patent Application Publication
(10) Pub. No.: US 2004/0174492 A1
(43) Pub. Date: Sep. 9, 2004

(54) Three-in-one multifunctional glasses

(76) Inventor: Eduardo De Queiroz Scherer, Florianopolis (BR)

Correspondence Address: Amilto Manfredi, First World of Brazil/Primeiro Mundo do Brazil, Rua Conselheiro Mafra, 426 SL-101, FLORIANOPOLIS, 888010-102, BR

(21) Appl. No.: 10/447,605

(22) Filed: May 29, 2003

(30) Foreign Application Priority Data
Mar. 7, 2003 (BR) PI 0300536-4

(51) Int. Cl. G02C 1/00; G02C 5/00

(52) U.S. Cl. 351/142

(57) ABSTRACT

The present invention, gathers in just one single piece the functions of sunglasses, glasses for cycling or beach sports and swimming goggles, thus providing convenience, comfort and higher protection to the user's ocular area for each usage need.

The said three-in-one glasses are comprised of two lenses or frame with one or two lenses (1) whose fasteners (2) get the arms (3) for use in either the sunglasses or glasses for cycling/beach sports functions; alternatively, they get an adjuster (5) with a strap (6) for the swimming goggles function. For the swimming goggles and glasses for the cycling/beach sports functions, the lenses or frame with lenses (1) get the gaskets (4) to protect the eyes or the internal part of the lenses against the entrance of water, perspiration or sand, to cushion possible impact against the glasses, and, in the swimming goggles function, to ensure the sealing of the glasses, thus preventing the entrance of water in the lenses.

The present invention refers to a multifunctional pair of glasses that performs the functions of sunglasses, cycling glasses or glasses for beach sports, and swimming goggles in a single piece, thus providing higher convenience, comfort and protection to the user's eyes.

Nowadays, the existing glasses meet only one or two of these needs at the most, without characteristics that adjust to each function, and posing the further inconvenience for the user of carrying two or three products to meet their needs. The swimming goggles and the sports glasses are worn just for these specific purposes, whereas some sunglasses are sometimes worn when cycling or practicing beach sports, posing some inconveniences: in certain circumstances, sand, perspiration or water can get into the internal part of the lenses or the user's eyes, jeopardizing the vision, and in the event of impact against the lenses, the ocular area can be left unprotected.

The present invention was developed in order to provide a three-in-one product and to solve the inconveniences found by cyclists, beach sports players and swimmers. This invention enables the adjustment of the glasses through mounting to every occasion and need, without the need for three glasses, one for each function. These characteristics provide higher convenience, comfort and protection to the eyes, preventing the entrance of perspiration, water or sand in the eyes and the internal part of the lenses, favoring the vision and offering protection to the ocular area by cushioning possible impact of objects against the lenses.

The great inconvenience that makes impossible the use of swimming goggles for cycling or beach sports, which could solve some of the problems mentioned, is the discomfort caused to the user by the suction from the gaskets as a result of the pressure exercised by the strap. The present invention solves this problem. With a small adjustment, the product can be used in both situations. By replacing the strap of the swimming goggles with sunglasses arms, the suction cup will remain in touch with the face, but now without the inconvenient suction caused by the strap, thus solving the problem of eyes and internal part of the lenses protection against sand, water, or perspiration, and also cushioning a possible impact against the glasses. The arms will just keep the glasses in their place, without exercising any pressure on the lenses, thus preventing the suction from the gaskets. The fitting system allows choosing the swimming function by fitting the strap into the fastener, or the sports glasses function by fitting the glasses arms into the fastener.

The present invention also includes a third function, the sunglasses one, which can be set up by fitting the glasses arms into the fastener and removing the gaskets. This gives the glasses a less sporting and more social look.

The said three-in-one glasses comprise one or two lenses, or a frame with one or two lenses, where two small gaskets or a larger one can be fastened in order to protect the eyes and the internal part of the lenses from sand, perspiration or water, and cushion possible impact against the glasses. In case of use as sunglasses, the arms should be used and the gaskets removed.

The invention can be better understood through the following detailed description, together with the figures enclosed, so that:

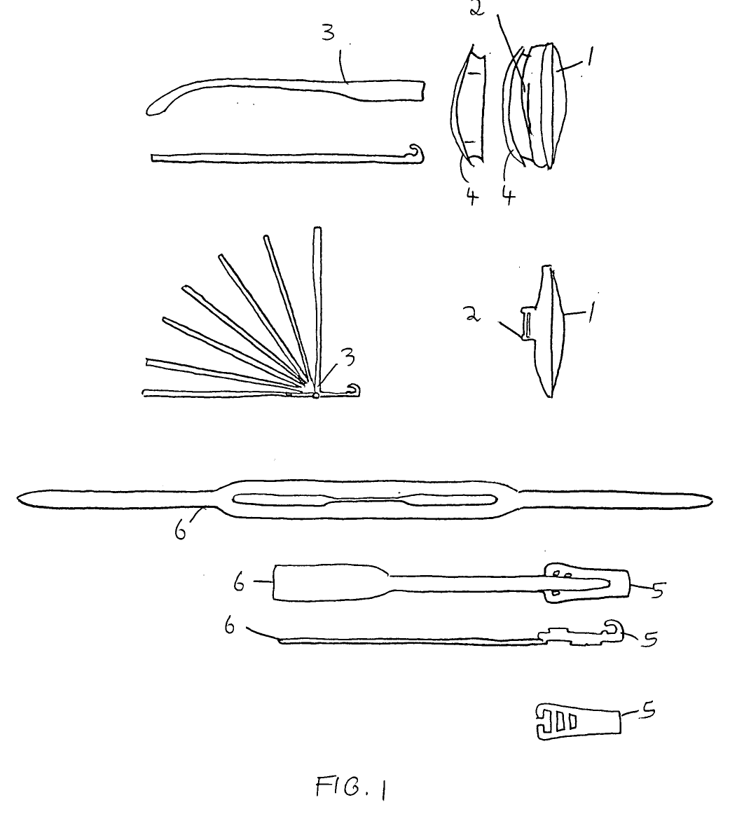

FIG. 1 shows the glasses components;

FIG. 2 shows a front view in perspective of the glasses in its swimming goggles function.

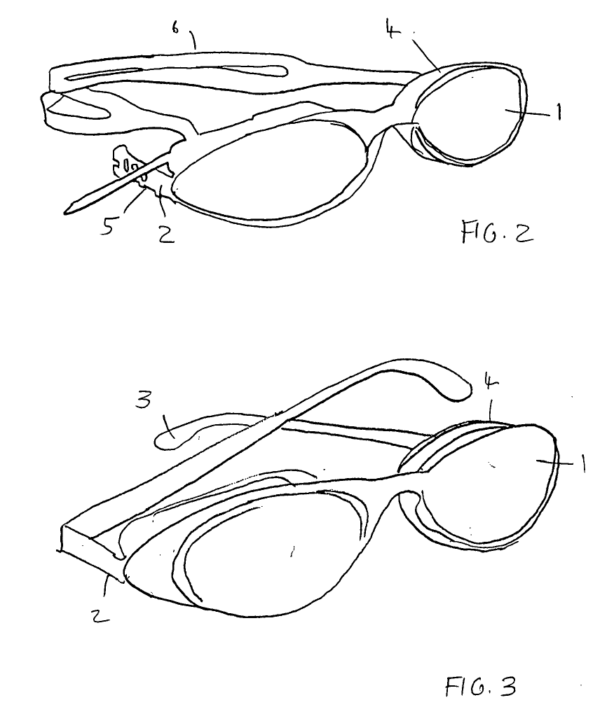

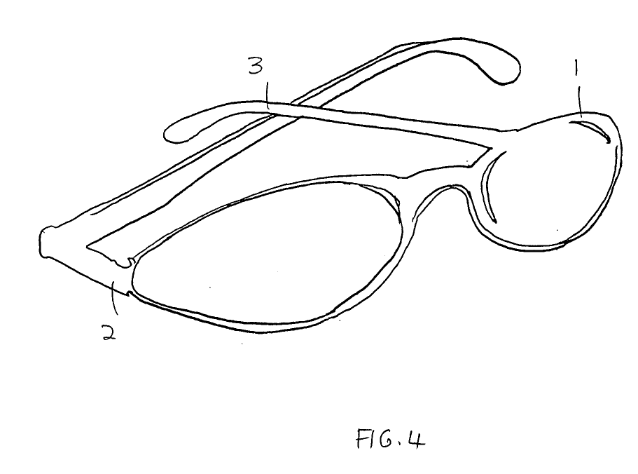

FIG. 3 shows a front view in perspective of the 1

glasses in its cycling or beach sports function.

FIG. 4 shows a front view in perspective of the glasses in its sunglasses function.

The lenses or frame with lenses (1) get the arms (3) in their fixed fittings (2) and the gaskets (4) for use in the function sports glasses for cycling or beach sports (FIG. 3). The gaskets (4) have the function of protecting the eyes and the internal part of the lenses against perspiration, water or sand, keeping these elements from getting into the eyes or the internal part of the lenses, providing higher protection and visibility; the gaskets can also absorb shock in the area between the glasses lenses and the user's ocular area, in case of impact of some object against the glasses. These gaskets (4) can be removed so that the glasses can be used in the sunglasses function (FIG. 4). The lenses or frame with lenses (1) get the adjuster (5) with the strap (6) fit, as well as the gaskets (4) so that the glasses can be used in the swimming goggles function (FIG. 2). In this function, the purpose of the gaskets (4) is to prevent the entrance of water onto the lenses, ensuring sealing of the glasses.

The fastener (2) has the functions of receiving the adjuster (5) with the strap (6) fitted for the swimming goggles function (FIG. 2), or the arms (3) for use as sunglasses (FIG. 4) or glasses for cycling and beach sports (FIG. 3).

The glasses also allow conventional operation as one-purpose glasses: they can be used only as swimming goggles, glasses for cycling and beach sports, or as sunglasses.

The adjustment or mounting of the glasses can be done in three ways. Firstly, by fastening only the arms (3) to the lenses or a frame with lenses (1) through the fastener (2) for use as sunglasses (FIG. 4); secondly, by fastening the arms (3) to the lenses or frame with lenses. (1) through the fastener (2) and fitting the gasket (4) into the lenses or frame with lenses (1) for the function sports glasses for cycling or beach sports (FIG. 3); and thirdly, by fastening the adjuster (5) with the strap (6) to the lenses or frame with lenses (1) through the fastener (2) and fitting the gaskets (4) into the lenses or frame with lenses (1) for the swimming goggles function (FIG. 2).

The operation of the glasses happens in the same way. Firstly, by fastening the arms (3) of the glasses to their lenses or frame with lenses (1) through the fastener (2) for use as sunglasses (FIG. 4); the gaskets (4) are added for use as glasses for cycling or beach sports (FIG. 3); and the arms (3) are substituted by the adjusters (5) with the fitted strap (6), the gasket being kept to use the glasses as swimming goggles (FIG. 2).

1^{st}) “THREE-IN-ONE MULTIFUNCTIONAL GLASSES”
Characterized by the combination of functions, as follows: glasses for cycling or beach sports, sunglasses and swimming goggles in one single piece.

2^{nd}) “THREE-IN-ONE MULTIFUNCTIONAL GLASSES”
According to claim number 1, the product is characterized by being comprised of two lenses or frame with one or two lenses (1) with fixed fitting (2); gaskets (4) to protect the eyes and the internal part of the lenses against perspiration, water or sand in the glasses for cycling/beach sports function, and to seal the glasses, thus preventing the entrance of water in the lenses in the swimming goggles function; movable and removable arms (3) for use as sunglasses and glasses for cycling/beach sports; and adjusters (5) with removable strap (6) that replace the arms (3), keeping the gaskets (4) in place, for use as swimming goggles.
